(19) United States
(12) Patent Application Publication
(10) Pub. No.: US 2026/0241926 A1
(43) Pub. Date: Aug. 20, 2026

(54) Computer-Implemented Method and System for Behavioral Planning

(71) Applicant: Robert Bosch GmbH, Stuttgart (DE)

(72) Inventors: Juergen Mathes, Stuttgart-Moehringen (DE); Markus Mazzola, Tuebingen (DE); Max Keller, Berlin (DE); Maxim Dolgov, Renningen (DE)

(21) Appl. No.: 19/540,920

(22) Filed: Feb. 16, 2026

(30) Foreign Application Priority Data
Feb. 17, 2025 (DE) 10 2025 105 728.1

(51) Int. Cl. B60W 30/09; B60W 30/095; G06Q 10/06

(52) U.S. Cl. CPC B60W 30/09; B60W 30/0956; G06Q 10/06

(57) ABSTRACT

A method for operating an ego vehicle in a traffic scene includes identifying an actual state of the traffic scene, and generating a tree structure of future states of the traffic scene for each planning component of a set of different planning components based on the actual state. The method further includes predicting the future states for a predetermined number of successive time steps. The future states include a plurality of child future states and a plurality of parent future states. Each child future state results from exactly one parent future state from a preceding time step. Any number of child future states results from one parent future state. The method further includes planning at least one behavior of the ego vehicle for the traffic scene of a corresponding parent future state to predict corresponding child future states using a respective planning component of the set of different planning components.

This application claims priority under 35 U.S.C. § 119 to patent application no. DE 10 2025 105 728.1, filed on Feb. 17, 2025 in Germany, the disclosure of which is incorporated herein by reference in its entirety.

### BACKGROUND

The invention relates to a computer-implemented method for planning the behavior of an at least partially automated ego vehicle in a traffic scene, wherein the actual state of the traffic scene is first identified, wherein a planning component is then selected from a given set of different planning components based on the identified actual state, and wherein the behavior of the ego vehicle is planned by using the selected planning component.

Furthermore, the invention relates to a computer-implemented system for planning a behavior of an at least partially automated ego vehicle in a traffic scene, at least comprising:
a perception level for identifying an actual state of a traffic scene, a set of different planning components for planning the behavior of the ego vehicle in a traffic scene and a computing unit for selecting a planning component from the given set of planning components.

The invention proceeds from a modular approach to autonomous driving, according to which the task of driving an ego vehicle is divided into the following sub-tasks: perception, prediction, planning and activation of the actuators. A dedicated system component is provided for each of these sub-tasks. In particular for perception, prediction, and planning, the use of learned methods, such as machine learning-based (ML) and deep learning-based (DL) methods, has established itself as a “de facto” standard, since these methods can take into account diverse contextual information without the need to explicitly model the context.

In order to be able to plan safe and comprehensible maneuvers, the situation, in which the ego vehicle is currently located, needs to be identified and analyzed. To this end, scene-specific information as of the current time is aggregated and processed. This is the perception task.

The result of the perception is used to anticipate the future development of the identified traffic scene. It is of particular interest how other participants in the traffic scene, e.g. motorized vehicles, cyclists, and pedestrians, will behave in the future. ML-based and DL-based predictive components typically generate a specified number of different possibilities for the development of the traffic scene, which is referred to as multimodal prediction. The different behavioral options of the individual participants are predicted, for example, in the form of actions, such as steering angles or accelerations, or also in the form of trajectories or future occupancy grids.

The results of the prediction can be used in addition to the results of the perception in behavioral planning of the ego vehicle for the currently identified traffic scene.

The behavioral planning methods or components may be substantially divided into three classes: the class of rules-based and/or optimization-based methods, the class of learned methods, and the class of hybrid methods that represent a combination of rules-based and optimization-based methods and learned methods. The class of learned methods includes deterministic methods that provide exactly one suggestion for the future behavior of the ego vehicle and stochastic methods that provide a probability distribution about possible behavioral options of the ego vehicle as output.

Rules-based and/or optimization-based planning methods are often only designed for certain scenarios and/or maneuvers and, therefore, are not useful in all possible traffic scenes. Learned planning methods can be more generally designed so that they master as many relevant scenarios and maneuvers as possible. The training effort is correspondingly high in these cases and the planning results are comparatively non-specific. Alternatively, learned planning methods may also be specialized in individual scenarios and maneuvers. For example, one planning component may be specialized in highway scenarios, while another planning component covers intersection scenarios. Such planning components deliver very good planning results as long as they are used according to their specialization.

It is known to have several differently configured specialized planning components for the behavioral planning of an ego vehicle and to use them as a function of the actual state of the traffic scene in order to accommodate the variety of different scenarios that occur in practice. The selection of the appropriate planning component in these known methods is always made based on an analysis of the actual state of the traffic scene. The possible future developments in the traffic scene are not taken into account.

### SUMMARY

With the present invention, measures are proposed that contribute to an improvement of the behavioral planning for an ego vehicle by selecting the planning component of a given set of different planning components whose configuration and/or specialization is best aligned with the possible future developments of the current traffic scene.

According to the present invention, the possible future developments of the traffic scene are taken into account in the selection of the planning component in that a tree structure of future states of the traffic scene based on the actual state is generated for each planning component of the given set. For this purpose, states are predicted for n successive time steps, wherein each predicted state (child state) results from exactly one state from the preceding time step (parent state), while any number of child states may result from one parent state. At least one behavior of the ego vehicle is planned for the traffic scene of the parent state to predict the child states by using the respective planning component. The child states are assessed and the assessment of the respective associated parent state is determined or modified by taking into account the assessments of the child states. In this way, a separate assessment of the actual state is made by using each planning component. According to the invention, the planning component is then selected based on the thereby generated different assessments of the actual state.

The computing unit of the claimed behavioral planning system is designed according to the invention to generate, for each planning component of the given set, a tree structure of future states of the traffic scene based on an identified actual state, wherein states are predicted for n successive time steps and each predicted state (child state) results from exactly one state from the preceding time step (parent state), while any number of child states may result from one parent state. At least one behavior of the ego vehicle is planned for the traffic scene of the parent state to predict the child states by using the respective planning component. In addition, the child states are assessed and the assessment of the respective associated parent state is determined or modified by taking into account the assessments of the child states. In this way, an assessment of the actual state is made according to the invention by using the respective planning component. The computing unit is further designed according to the invention to select a planning component from the given set based on the thereby generated different assessments of the actual state, and to use it to plan the behavior of the ego vehicle in the identified actual state of the traffic scene.

According to the invention, the selection of a particular planning component from a given set of different planning components is thus based on a tree search based method. It is known to use such methods, such as the Monte Carlo tree search (MCTS) in conjunction with learned stochastic planning components, to select a behavioral option from a distribution that is then to be used as a basis for controlling the actuators. The predictive component and the planning component are used to predict and/or estimate possible future states of the identified traffic scene. These predicted states are then assessed to select a behavioral option for the current situation based on the respective quality of the future states. The quality of predicted future states of the traffic scene is then subjected to backpropagation through time in order to decide on the behavior of the ego vehicle at the current time. This procedure is based on the idea that the behavior of the ego vehicle affects the future development of the traffic scene and should, therefore, be planned or selected to the greatest extent possible so that the traffic scene develops in as favorable a manner as possible in terms of a specified quality criterion.

According to the invention, it has been recognized that this concept is not only suitable for the selection of a specific behavior, but can also be used for the selection of a planning component. Therefore, for each individual planning component of the given set, possible future developments of the current traffic scene will be extrapolated and evaluated based on specified quality criteria. Since the future developments of the traffic scene extrapolated in this manner are influenced by the respective planning component, the assessments of these possible future developments represent a sensible selection criterion for the planning component, which is also more meaningful than just the current state of the traffic scene.

Advantageously, the planning components of the given set of planning components differ in their specialization by being designed for different planning tasks, particularly for different traffic scenarios and/or for different driving maneuvers. Thus, a different behavior for the ego vehicle that is adapted to the type of traffic scene can then also be planned in traffic scenes of different types, such as highway travel and city traffic or straight ahead travel and intersection situations.

The set of planning components that are used by the method according to the invention or system, can include both rules-based and/or optimization based planning components as well as learned deterministic or stochastic planning components and hybrid planning components. Simpler travel functions, such as keeping certain distances away from the vehicle traveling in front, can be implemented very well using rules-based and/or optimization-based planning components, while mostly learned planning methods are used for the realization of more complex travel functions, such as an automatic passing maneuver.

As already explained, according to the present invention, a tree structure of future states of the traffic scene is generated for each planning component of the given set of planning components based on the current traffic scene, i.e., the actual state. For this purpose, states are predicted for n consecutive time steps.

In an advantageous variant of the invention, prediction of such a state, in addition to planning at least one behavior of the ego vehicle for the traffic scene of the parent state, also comprises prediction of at least one development of the traffic scene of the respective parent state.

For example, the prediction of the development of the respective traffic scene may relate to the development of lighting and/or weather conditions and/or to the geographic conditions that change as the journey proceeds. Of particular advantage is when different behavioral options of additional participants in the traffic scene are also predicted as part of the prediction of the development of the respective traffic scene, which is referred to as multimodal prediction.

As different actions and trajectories of other participants have a huge impact on the development of the traffic scene, they should be considered in the behavioral planning for the ego vehicle to ensure the safety of all participants. Therefore, in an advantageous embodiment of the invention, at least a portion of the planning components of the given set is designed such that, in addition to the respective parent state of the traffic scene, the prediction of the development of the traffic scene of the parent state is also taken into account in the behavioral planning for the ego vehicle.

Essential for the selection of a planning component according to the invention from the given set of planning components is the assessment of the states of the tree structures that were generated with the individual planning components available for selection. Preferably, a quality is determined for each state based on specified quality criteria. For example, aggregate costs and/or advantages of the state are suitable quality criteria. Corresponding cost functions may be defined based on model, such as, for example, time-to-collision between the ego vehicle and other participants in the traffic scene, acceleration/jerk, and/or impact on other participants. However, the quality or the costs can also be learned. In this case, the quality or costs is an abstract variable, which may be interpreted as a similarity of a predicted state to a state known from the training data, i.e., how plausible is the planned scene compared to the training data. According to the present invention, the assessment of a parent state is determined or modified while taking into account the assessments of the child states. Thus, the parent states can be simply assessed based on a mean quality of their respective child states.

If the parent states are assessed based on the maximum quality of the respective child states, then, at the end, the planning component can be identified and selected for which an extrapolated future, i.e., a branch of the corresponding tree structure, has a higher quality than all other branches of such tree structure and all futures extrapolated with other planning components. This corresponds to the selection of a planning component, for which a future looks most promising.

Alternatively, the parent states may also be assessed based on the lowest quality of the respective child states. In this case, in the end, the planning component may be selected, for which the extrapolated future with the lowest quality has a higher quality than all other extrapolated low-quality futures of its tree structure and all futures extrapolated with other planning components. This corresponds to the selection of a planning component, for which the worst future is the best compared to the worst futures of other planning components.

In a preferred variant of the method or system according to the invention, the tree search based selection of a planning component from the given set of planning components is additionally utilized for the behavioral planning of the ego vehicle. For this purpose, only the states of that tree structure, which was generated by using the selected planning component, are considered. Taking into account the different assessments of these states, a child state resulting from the actual state is then selected and the corresponding behavior of the ego vehicle is determined as a result of the behavioral planning.

In this case, therefore, at the same time as the tree search based selection of the planning component that is best suited for the actual state of the traffic scene, the best behavioral planning for the ego vehicle that was generated when creating the corresponding tree structure is selected. Since the previously performed tree search has already made a quality assessment of the child states generated by using the selected planning component and, thus indirectly, also an assessment of the behavior leading to these child states of the ego vehicle, these need not be assessed again. It is merely necessary to select the behavior of the ego vehicle that leads to the child-state of maximum quality. Another iteration of behavioral planning with the selected planning component is therefore not required in this case. This may reasonably limit computational time for the overall planning process, which comprises selection of the planning component and behavioral planning.

This procedure proves to be particularly advantageous if the given set of planning components comprises only deterministic planning components. Branches within the respective tree structures then arise exclusively due to the stochasticity or multimodality of prediction, in particular prediction of the behavior of additional participants in the traffic scene. This is because the future behavior of the remaining traffic participants is not known and can only be estimated. Thus, multiple possible futures, referred to as modes, are usually predicted as part of the prediction.

If only deterministic planning components are available, the number of branches of each tree search will decrease so that the computational time for the method according to the invention will be reduced overall.

### BRIEF DESCRIPTION OF THE DRAWINGS

First, a tree search is described below with respect to how it could be used in the context of the invention. Afterward, exemplary embodiments and advantageous further developments of the invention are explained in more detail in the following in conjunction with the figures.

FIG. 1 illustrates the development of a tree structure of future states of a traffic scene, the future states are predicted by using a planning component that provides two behavioral options for an ego vehicle for each parent state.

FIG. 2A and FIG. 2B illustrate the development of tree structures of future states of a traffic scene, wherein the states are each predicted by using a predictive component and a planning component.

FIG. 3 illustrates the use of a tree search as part of the method according to the invention for planning a behavior of an at least partially automated ego vehicle in a traffic scene.

FIG. 4 shows a block diagram of a system according to the invention for planning a behavior of an at least partially automated ego vehicle in a traffic scene.

### DETAILED DESCRIPTION

In principle, a tree search consists of four phases that are repeated in order to generate a tree structure of future states of the traffic scene starting from an actual state of a traffic scene. The tree structure is expanded by predicting states for n successive time steps, wherein each predicted state (child-state) results from exactly one state from the preceding time step (parent-state), while any number of child states may result from a parent state.

In phase 1 of the tree search, a child state is selected. Therefore, phase 1 is referred to as “selection”.

In phase 2, child states are predicted for the selected state. These child states are referred to as expanded states of the state selected in phase 1. Therefore, phase 2 is referred to as “expansion.”

In phase 3, referred to as “simulation,” the expanded states are evaluated using a quality function by determining a quality for each child state predicted in phase 2.

Phase 4 of the tree search is referred to as “backpropagation,” because here the quality of the parent states is determined or updated based on the quality of the respective child states. Often, the average quality of the child states is chosen as the parent-state quality. It is essential that not only the assessment of the state selected in phase 1 is updated in phase 4, but that the “backpropagation” of phase 4 can affect all assessments of the past states of the tree structure up to the assessment of the initial state, i.e., the actual state of the traffic scene.

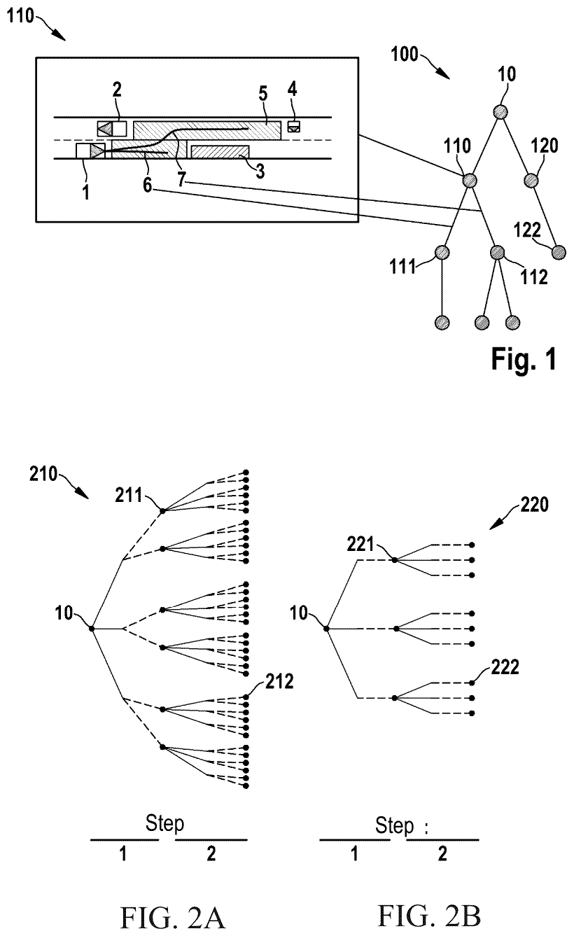

In FIG. 1, a tree structure 100 is shown, which is derived from an initial and actual state 10 of a traffic scene and has been expanded for three consecutive time steps. To this end, future states of the traffic scene were predicted for each time step, namely, in such a way that each predicted state (child state) results from exactly one state from the preceding time step (parent state). Starting from the actual state 10, in the first time step, the child states 110 and 120 were generated, which function as parent states for states 111, 112, and 122 of the second time step, etc. In the present case, two child states emerge from each parent state, wherein not all states of the tree structure are shown here for clarity. For the prediction of the child states, a planning component was used that utilizes only information about the parent state of the traffic scene and a state-based estimate of a safe area for the ego vehicle. The operation of this planning component is exemplified herein from the scene representation of the state 110 in FIG. 1.

In this traffic scene, the ego vehicle 1 is located on a two-lane road with oncoming traffic 2. In the lane of the ego vehicle 1, there is an obstacle 3 in the direction of travel of the ego vehicle 1. In addition, a pedestrian 4 is about to cross the road in the direction of travel in front of the ego vehicle 1. Based on the state information of this traffic scene 110, the planning component has identified the shaded area 5 as a safe area for the ego vehicle 1. Based on this, the planning component provides two behavioral options for the ego vehicle 1: Behavioral option 6 “Stop before the obstacle 3,” leading to the child state 111, and behavioral option 7 “Circumvent the obstacle 3 and swerve into the opposite lane to do so,” leading to the child state 112.

FIGS. 2A and 2B also show the tree structures 210 and 220, respectively, that are derived from an initial and actual state 10 of a traffic scene and have been expanded for successive time steps. In contrast to FIG. 1, however, the future states of the respective traffic scene were not only predicted by using a planning component for the behavioral planning of the ego vehicle, but also by using a predictive component. With this predictive component, the future development of the respective traffic scene was initially predicted, in particular the behavior of other participants in the traffic scene. The predictions of the predictive component are shown herein in the form of solid lines of the respective tree structures 210 and 220. Using this as a basis, behavioral options for the ego vehicle were then generated with the planning component. These behavioral options generated by the planning component are shown in the form of dashed lines of the respective tree structures 210 and 220.

FIGS. 2A and 2B illustrate how the use of a stochastic planning component (FIG. 2A) affects a tree search based behavioral planning method for an ego vehicle as opposed to the use of a deterministic planning component (FIG. 2B). In both cases, a multimodal predictive component was used to expand the tree structures 210 and 220, respectively, which component predicted three different developments of a given state of a traffic scene, i.e., three different modes. The different modes represent different but always scene-consistent behavioral options of the remaining participants in the traffic scene, e.g., in the form of trajectories or actions. In the case of FIG. 2A, a stochastic planning component was used that provides two samples from a distribution of possible behaviors of the ego vehicle for each predicted mode, thus allowing the selection between two behavioral options for the ego vehicle. By combining the multimodal prediction with this multimodal planning, six child states are generated for each state of the tree structure 210. Accordingly, the tree structure 210 of FIG. 2A, after the first predictive step, comprises 6 child states 211 of an actual state 10 and, after the second predictive step, comprises 36 child states 212 of states 211.

In contrast, in the case of FIG. 2B, a deterministic planning component was used, which provides exactly one possible behavior of the ego vehicle for each predicted mode, basically as a response to the different modes of the prediction. Accordingly, the tree structure 220 of FIG. 2B, after the first predictive step, comprises 3 child states 221 of an actual state 10 and, after the second predictive step, comprises 9 child states 222 of states 221.

The juxtaposition of FIGS. 2A and 2B illustrates that the use of deterministic planning components in the tree search requires less computational time and runtime than the use of stochastic planning components.

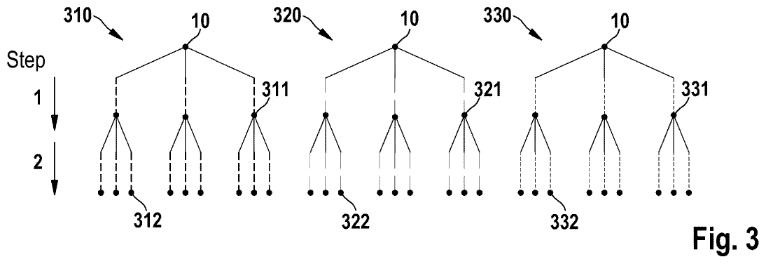

The selection of a planning component from a given set of different planning components as part of the behavioral planning according to the invention for an at least partially automated ego vehicle is essentially based on the fact that a separate tree structure of future states of the traffic scene is generated for each planning component of the given set based on the actual state of a traffic scene. This is illustrated by FIG. 3.

In the exemplary embodiment shown here, three different planning components are available, one of which is to be selected for planning the behavior of the ego vehicle in a given traffic scene. All three planning components are deterministic planners that utilize the result of a predictive component, as in the case of FIG. 1. In the present case, for each of the three planning components, a separate tree structure 310, 320, and 330, respectively, was expanded for two consecutive time steps based on the identified actual state 10 of the traffic scene. A multimodal predictive component was used to predict three different possible developments of the traffic scene based on a state of the traffic scene. The predictions of the predictive component are shown here as solid lines of the respective tree structure 310, 320, and 330, as shown in FIGS. 2A, 2B. Then, for each mode thereby predicted, a behavioral option of the ego vehicle was planned in order to generate subsequent states or child states. For each of the three tree structures 310, 320, and 330, a different one of the three planning components to select from was used. This is shown here in the form of the different dashed-line branches of the tree structures 310, 320, and 330. Due to the use of different planning components, the three tree structures 310, 320, and 330 differ in their subsequent states-the three child states 311, 321, and 331, respectively, after the first time step and the nine child states 312, 322, and 332, respectively, after the second time step, although all three tree structures emerge from the same actual state 10 of a traffic scene and the same multimodal predictive component was used when extrapolating the states.

As described above, the predicted states were evaluated when the tree structures 310, 320, and 330 were expanded using a quality function. The thereby determined quality values of the individual states were then updated by backpropagation within the individual tree structures 310, 320, and 330. In this way, three different quality values were determined for the actual state 10, which forms the initial state for all three tree structures 310, 320, and 330. These different assessments of the actual state 10 are an indicator of how well the respective planning component is designed for the actual state 10 of the given traffic scene, but also for its possible developments. In the present case, the tree structure 330 provides the best assessment of the actual state 10. Accordingly, the planning component for planning the behavior of the ego vehicle in the given traffic scene 10 is selected.

This selection is based on the recognition that the quality of the initial state of the tree structures determined by the backpropagation represents an average measure of the quality of the future states, i.e., a measure of the average quality of the future if the respective planning component is selected in the currently given traffic scene.

Thus, the algorithm which uses a tree search, such as MCTS, to select a planning component from a given set of N planning components, is as follows: (i) apply the tree search for all N planning components to calculate the quality of the initial state kᵢ, i={1, 2, . . . , N} of all tree structures of the N planning components, (ii) Select the planning component with the highest quality value.

J=Argmaxᵢ(kᵢ)

In the present case, however, the tree structure 330 is not only used to select the most suitable planning component, but also for actual behavioral planning. Namely, based on the quality value of the child states 331, one of the three planned behavioral options is selected to control the actuators of the ego vehicle accordingly.

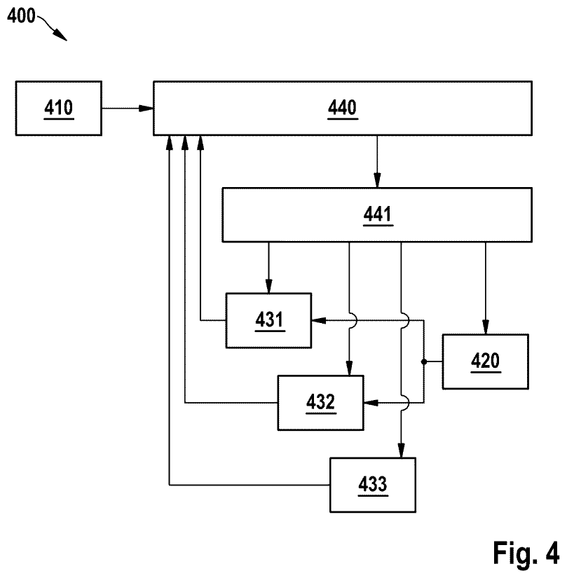

The system 400 shown in FIG. 4 for planning a behavior of an at least partially automated ego vehicle in a traffic scene comprises a perception level 410 for detecting an actual state of a traffic scene.

The perception level aggregates scene-specific information of the current traffic scene from different sources of information. These can be in-vehicle sensors, such as LiDAR sensors, radar sensors and/or RGB cameras installed on the ego vehicle, or non-vehicle sensors, such as LiDAR sensors, radar sensors, and/or RGB cameras installed in or on infrastructure elements. Other possible sources of information include stored map information as well as retrievable weather and road condition information, traffic situation information, etc. Mostly, the so aggregated scene-specific information is also pre-processed from the perception level 410 into contextual information. The perception level 410 may also generate different representations of the actual state of a traffic scene based on the aggregated scene-specific information, such as a birds-eye view and/or graphic representation, depending on the type of planning components 431, 432, and 433 available.

Furthermore, the system 400 shown here includes a predictive component 420 for predicting the future development of a traffic scene. In the exemplary embodiment described herein, it is a multimodal predictive component that provides a specified number of different behavioral options for other participants of the traffic scene as possible futures. The system 400 further includes a set of different planning components 431, 432, and 433 for planning the behavior of the ego vehicle in a given traffic scene. The two planning components 431 and 432 utilize the results of the predictive component 420 to generate one or more behavioral options for the ego vehicle, while the planning component 433 generates one or more behavioral options for the ego vehicle independent of the predictive component 420.

Finally, the system 400 also comprises a computing unit 440 for selecting one of the available planning components 431, 432, or 433 for planning the behavior of the ego vehicle in the current traffic scene. According to the present invention, this computing unit 440 is designed to generate a tree structure of future states of the traffic scene for each planning component 431, 432 and 433 of the given set based on an actual state identified using the perception level 410. For each of these three tree structures, states are predicted for n successive time steps, wherein each predicted state (child state) results from exactly one state from the preceding time step (parent state), while any number of child states may result from one parent state. The states of such a tree structure are each predicted using a planning component 431, 432, or 433, and in the cases of planning components 431 and 432 also using the predictive component 420. Although the tree structures thus generated all originate from the same actual state of the traffic scene, they therefore differ at least in their subsequent states.

When the tree structures are expanded in each time step, the computing unit 440, provides a parent state of the tree structure to be expanded for the individual predictions of the child states, which is shown in the form of block 441. The computing unit 440 thus ensures that both the predictive component 420 and the respective planning components 431, 432 or 433 for predicting a child state always proceed from the parent state of the respective tree structure.

Furthermore, according to the present invention, the computing unit 440 is designed to assess the child states of the tree structures generated with the different planning components 431, 432 and 433 and to determine or modify the assessment of the respective associated parent states while taking into account the assessments of the child states. By means of backpropagation within the three different tree structures, the computing unit 440 can perform three different assessments of the actual state. The differences in actual state assessment are due to the use of the different planning components 431, 432, and 433 in creating the tree structures. The computing unit 440 uses these differences in the assessment of the actual state of the traffic scene as a criterion for selecting one of the available planning components 431, 432 and 433.

What is claimed is:

1. A method for operating an ego vehicle in a traffic scene, comprising:
identifying an actual state of the traffic scene;
generating a tree structure of future states of the traffic scene for each planning component of a set of different planning components based on the actual state;
predicting the future states for a predetermined number of successive time steps, the future states including a plurality of child future states and a plurality of parent future states, each child future state results from exactly one parent future state from a preceding time step, and any number of child future states results from one parent future state;
planning at least one behavior of the ego vehicle for the traffic scene of a corresponding parent future state to predict corresponding child future states using a respective planning component of the set of different planning components;
assessing the corresponding child future states, and determining or modifying an assessment of the corresponding parent future state based on the assessment of the corresponding child future states, such that an assessment of the actual state of the traffic scene is made for each planning component in the set of different planning components;
selecting a selected planning component of the set of different planning components based on the assessment of the actual state of the traffic scene; and
operating the ego vehicle based on the selected planning component.

2. The method according to claim 1, further comprising:
predicting the plurality of child future states by predicting at least one development of the traffic scene of the corresponding parent future state including predicting at least one behavioral option of at least one participant in the traffic scene.

3. The method according to claim 2, wherein at least one planning component of the set of different planning components considers the prediction of the at least one development of the traffic scene when planning the at least one behavior of the ego vehicle.

4. The method according to claim 1, further comprising:
determining a quality for each future state of the tree structure; and
assessing each parent state of the plurality of parent future states based on (i) a mean quality of the corresponding child future states, (ii) a maximum quality of the corresponding child future states, or (iii) a lowest quality of the corresponding child future states.

5. The method according to claim 1, wherein the at least one behavior of the ego vehicle is planned by using the selected planning component for a child state of the plurality of child future states of the tree structure resulting from the actual state.

6. A system for operating an ego vehicle in a traffic scene, comprising:
a processor configured to:
identify an actual state of the traffic scene;
generate a tree structure of future states of the traffic scene for each planning component of a set of different planning components based on the actual state;
predict the future states for a predetermined number of successive time steps, the future states including a plurality of child future states and a plurality of parent future states, each child future state results from exactly one parent future state from a preceding time step, and any number of child future states results from one parent future state;
plan at least one behavior of the ego vehicle for the traffic scene of a corresponding parent future state to predict corresponding child future states using a respective planning component of the set of different planning components;
assess the corresponding child future states, and determining or modifying an assessment of the corresponding parent future state based on the assessment of the corresponding child future states, such that an assessment of the actual state of the traffic scene is made for each planning component in the set of different planning components;
select a selected planning component of the set of different planning components based on the assessment of the actual state of the traffic scene; and
operate the ego vehicle based on the selected planning component.

7. The system according to claim 6, wherein each planning component of the set of different planning components is for different traffic scenarios and/or for different driving maneuvers.

8. The system according to claim 6, wherein the set of different planning components includes (i) at least one learned deterministic or stochastic planning component, (ii) at least one rules-based and/or optimization-based planning component, and/or (iii) at least one hybrid planning component.

9. The system according to claim 6, wherein the processor is further configured to predict at least one future development of the traffic scene including predicting at least one behavioral option of at least one participant in the traffic scene.

10. The system according to claim 9, wherein at least one planning component of the set of different planning components is based on the prediction of the at least one future development of the traffic scene.

11. The system according to claim 9, wherein the processor is further configured to plan the at least one behavior of the ego vehicle using the selected planning component for a child state of the plurality of child future states of the tree structure resulting from the actual state.
